(19) United States
(12) Patent Application Publication
(10) Pub. No.: US 2010/0139267 A1
(43) Pub. Date: Jun. 10, 2010

(54) SECONDARY AIR SYSTEM FOR A COMBUSTION ENGINE BREATHING SYSTEM

(75) Inventors: Dirk Schliesche, Billingheim (DE); Volker Joergl, Ortonville, MI (US)

Correspondence Address: REISING, ETHINGTON, BARNES, KISSELLE, P.C., P. O. BOX 4390, TROY, MI, 48099-4390, US

(73) Assignee: BorgWarner Inc., Auburn Hills, MI (US)

(21) Appl. No.: 12/523,371

(22) PCT Filed: Jan. 27, 2008
(86) PCT No.: PCT/US08/52142

§ 371 Date: Jan. 18, 2010

Related U.S. Application Data
(60) Provisional application No. 60/886,921, filed on Jan. 27, 2007.

(51) Int. Cl. F02D 23/00; F02B 33/44; F01N 3/035; F01N 3/10; F04D 29/56

(52) U.S. Cl. 60/602; 60/598; 60/297; 60/303; 60/299; 415/148

(57) ABSTRACT

One embodiment of the invention includes a method comprising: in a combustion engine breathing system having an air intake side and a combustion exhaust side, injecting air from the air intake side into the combustion gas exhaust side.

This application claims the benefit of U.S. Provisional Application Ser. No. 60/886,921, filed Jan. 27, 2007.

### TECHNICAL FIELD

The field to which the disclosure generally relates includes combustion engine breathing systems and components thereof, turbocharger systems and components and methods of making and using the same.

### BACKGROUND

FIG. 1 is a schematic illustration of a product or system 10 including a modern breathing system used for a single stage turbocharger. Such a system may include a combustion engine 12 constructed and arranged to combust a fuel, such as a diesel fuel in the presence of oxygen (air). The system 10 may further include a breathing system including an air intake side 14 and a combustion gas exhaust side 16. The air intake side may include an air intake manifold 18 connected to the combustion engine 12 to feed air into the cylinders of the combustion engine 12. A primary air intake conduit 20 may be provided and connected at one end to the air intake manifold 18 (or made a part thereof) and may include an open end 24 for drawing air therethrough. An air filter 26 may be located at or near the open end 24 of the primary air intake conduit 20.

The combustion gas exhaust side 16 may include an exhaust manifold 28 connected to the combustion engine 12 to exhaust combustion gases therefrom. The combustion gas exhaust side 16 may further include a primary exhaust gas conduit 30 having a first end 32 connected to the exhaust manifold 28 (or made a part thereof) and having an open end 34 for discharging exhaust gas to the atmosphere.

Such a system may further include a first exhaust gas recirculation assembly 40 extending from the combustion gas exhaust side 16 to the air intake side 14. A first exhaust gas recirculation (EGR) valve 46 may be provided in fluid communication with the primary exhaust gas conduit 30 and constructed and arranged to control the flow of exhaust gas from the exhaust side 16 to the air intake side 14 and into the combustion engine 12. The first EGR assembly 40 may include a primary EGR line 42 having a cooler 44 in fluid communication therewith for cooling the exhaust gas flowing through the primary EGR line 42.

The system 10 may further include a turbocharger 48 having a turbine 50, which may have a variable geometry, in fluid communication with the primary exhaust gas conduit 30 and having a compressor 52 in fluid communication with the primary air intake conduit 20 to compress gases flowing therethrough. An air charge cooler 56 may be provided in the primary air intake conduit 20 downstream of the compressor 52. In one embodiment, the compressor 52 may be a variable pressure compressor constructed and arranged to vary the pressure of the gas at a given flow rate. An air throttle valve 58 may be provided in the primary air intake conduit 20 preferably downstream of the air charge cooler 56. A number of emission control components may be provided in the primary exhaust gas conduit 30. For example, a particulate filter 54 may be provided downstream of the turbine 50 and additional emission control components such as a catalytic converter 36 and a muffler 38 may also be provided. Additional exhaust after-treatment devices such as lean NOₓ traps may also be provided.

A number of problems have been associated with the use and operation of systems such as that described above. For example, it would become necessary to regenerate the particulate filter 54 when the filter becomes filled with soot. To accomplish this, it may be desirable to deliver oxygen rich air to the combustion gas exhaust side 16 to either burning the rich fuel mixture (hydrocarbons, carbon monoxide), coming out of the engine during the regeneration cycle in the catalytic converter or particulate filter, or to supply an auxiliary fuel burner. These proposed solutions increase the exhaust temperature before/in the particulate filter to burn the accumulated soot in a rapid/efficient manner. In such a case, the pressure of the exhaust system before the particulate filter can be as high as 50 kPa.

In another approach, for reducing cold start emissions, oxygen rich air is needed in the combustion gas exhaust side 16 to burn HC/CO before or in the catalytic converter. The resulting exhaust temperature increase “lights off” the catalytic converter, which in turn then starts converting NOₓ, HC and CO. In this case the pressure in the exhaust system is typically very low, for example, less than 10 kPa.

In another approach, NOₓ after-treatment coatings may be applied to the particulate filter, catalytic converter or other device. These coatings are especially sensitive to high exhaust temperatures typically seen at high engine loads, so cooling the exhaust may be necessary. In such cases, the pressure in the exhaust system may be moderate, for example, less than 30 kPa.

The proposed system to overcome some of the shortcomings described above may include the use of an air pump (also called a secondary air pump), to provide a limited amount of airflow into the combustion gas exhaust side 16. However, typically secondary air pumps for gasoline engines are operated with a fan or impeller similar to that used with an air blower and for a relatively short period of time (for example, less than one minute) immediately after the engine starts, and therefore cannot work effectively against a very high pressure in the exhaust system for extended operation times. For example, for an operation time greater than 10 minutes, the flow produced by such a secondary air pump would be very limited (e.g., 2-25 cfm) unless the secondary air pump was substantially modified at substantial costs.

Another approach may be to use a secondary air pump to provide a limited amount of airflow into the combustion gas exhaust side 16. The air may be introduced into the primary exhaust gas conduit 30 before the catalytic converter and will result in the immediate burning of hydrocarbons (HC) and carbon monoxide (CO) in the exhaust pipe before the catalytic converter. Alternatively, a HC storage catalyst may be utilized to store HCs in the catalytic converter until the catalytic converter has started to convert the HC/CO emissions. However, both such solutions are costly and automobile manufacturers are hesitant to use them in many vehicles due to packaging constraints associated with one or more secondary air pumps in the engine compartments (e.g., V8-V12 engines) or the added cost and packaging concerns associated with a HC storage catalyst device.

Another possible solution involves using a water/exhaust heat exchanger to cool the exhaust gas to levels acceptable for exhaust after treatment. However, a heat exchanger that transfers heat from the exhaust into the engine cooling circuit would use the vehicle radiator to reject heat. Consequently, due to the high temperatures in the exhaust system associated with high engine cooling requirements this would result in a need for the radiator to be upsized to accommodate both requirements of engine cooling and heat exchanger cooling simultaneously. Additional costs are associated with such systems including control valves and sensors as well as meeting packaging requirements.

### SUMMARY OF EXEMPLARY EMBODIMENTS OF THE INVENTION

One embodiment of the invention includes a method comprising: in a combustion engine breathing system having an air intake side and a combustion exhaust side, injecting air from the air intake side into the combustion gas exhaust side.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings, wherein:

FIG. 1 is a schematic illustration of a prior art engine breathing system.

FIG. 2A is a schematic illustration of another embodiment of the invention.

FIG. 2B is a schematic illustration of another embodiment of the invention.

FIG. 2C is a schematic illustration of another embodiment of the invention.

FIG. 2D is a schematic illustration of another embodiment of the invention.

FIG. 2E is a schematic illustration of another embodiment of the invention.

FIG. 2F is a schematic illustration of another embodiment of the invention.

FIG. 3A is a graph of pressures at various locations in an air charge line according to one embodiment of the invention with no other device in the air charge line and where the air valve controls flow.

FIG. 3B is a graph of pressures at various locations in an air charge line according to one embodiment of the invention wherein no other device is in the air charge line and wherein the air valve is fully open.

FIG. 3C is a graph of pressures at various locations in an air charge line according to one embodiment of the invention wherein no other device is in the air charge line and wherein the air valve is fully closed.

FIG. 4A is a graph of pressures at various locations in an air charge line according to one embodiment of the invention wherein a fuel burner is positioned in the air charge line and wherein the air valve controls the airflow.

FIG. 4B is a graph of pressures at various locations in an air charge line according to one embodiment of the invention wherein a fuel burner is positioned in the air charge line and wherein the air valve is fully open.

FIG. 4C is a graph of pressures at various locations in an air charge line according to one embodiment of the invention with a fuel burner in the air charge line and wherein the air valve is fully closed and the burner off.

FIG. 5A is a graph of pressures at various locations in an air charge line according to one embodiment of the invention with a fuel burner and an air pump in the air charge line and wherein the air valve is fully open.

FIG. 5B is a graph of pressures at various locations in an air charge line according to one embodiment of the invention with a fuel burner and an air pump in the charge line and wherein the air valve is fully closed.

FIG. 6A is a graph of pressures at various locations in an air charge line according to one embodiment of the invention with a boost assist device in the air charge line and wherein the air valve is fully open.

FIG. 6B is a graph of pressures at various locations in an air charge line according to one embodiment of the invention with a boost assist device in the air charge line and wherein the air valve is fully closed.

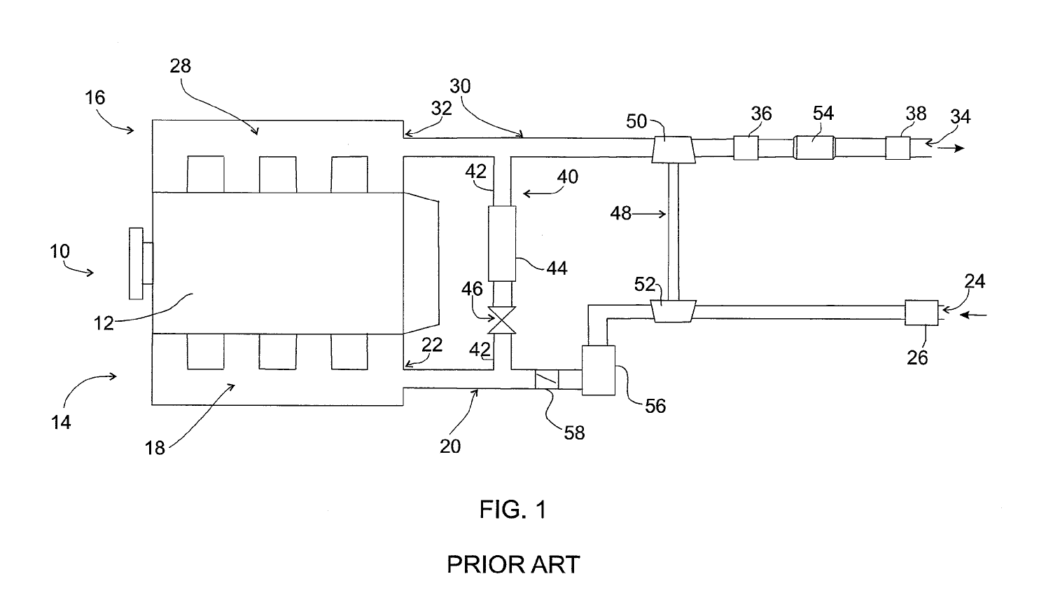

### DETAILED DESCRIPTION OF EXEMPLARY EMBODIMENTS

The following description of the embodiment(s) is merely exemplary in nature and is in no way intended to limit the invention, its application, or uses.

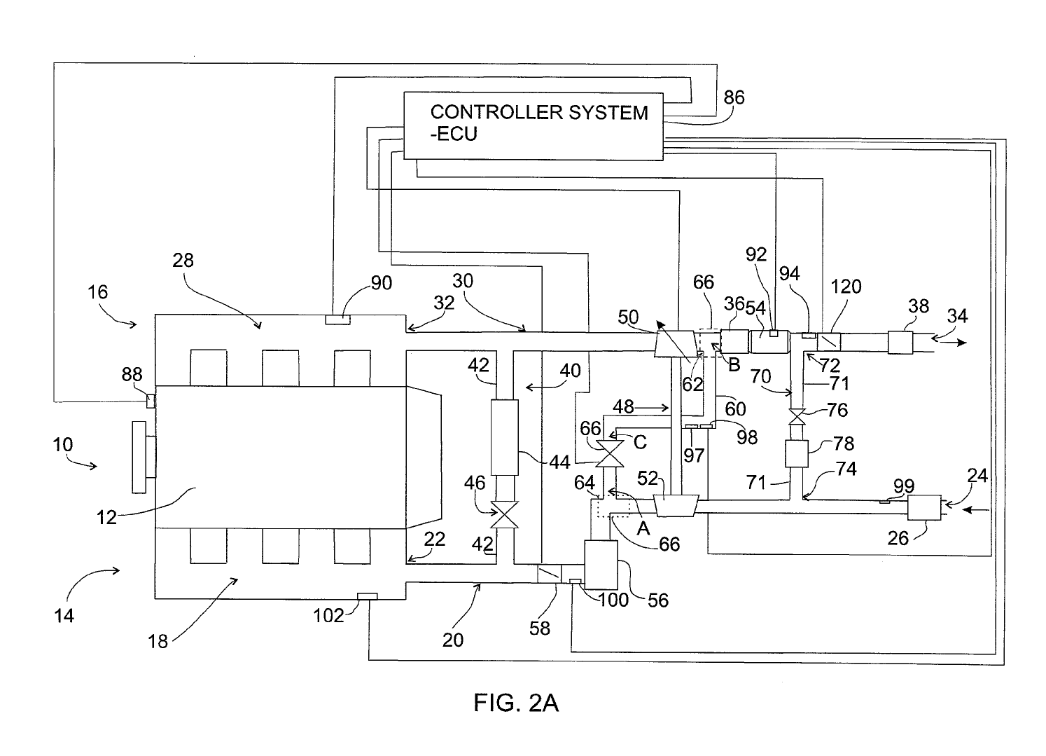

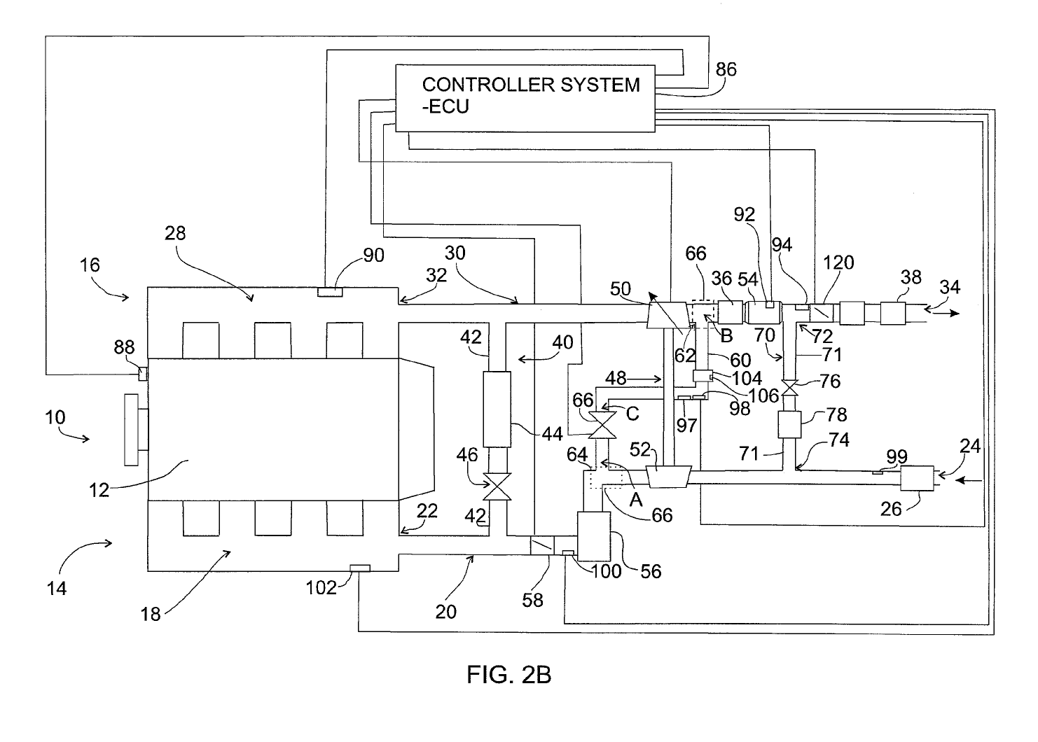

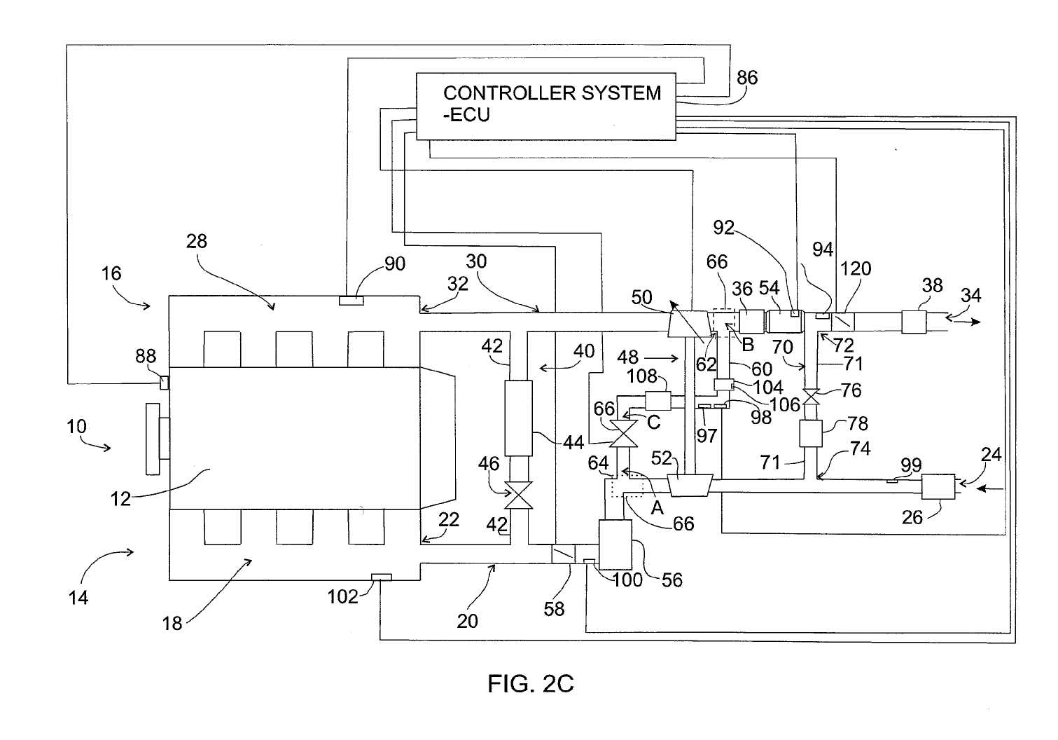

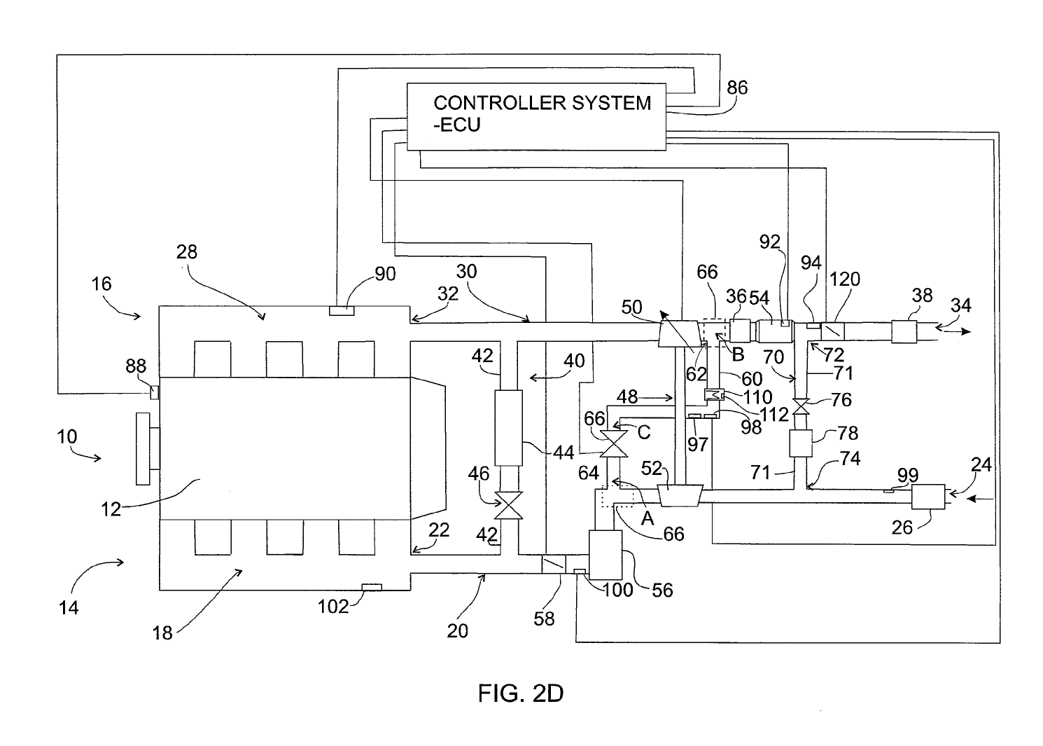

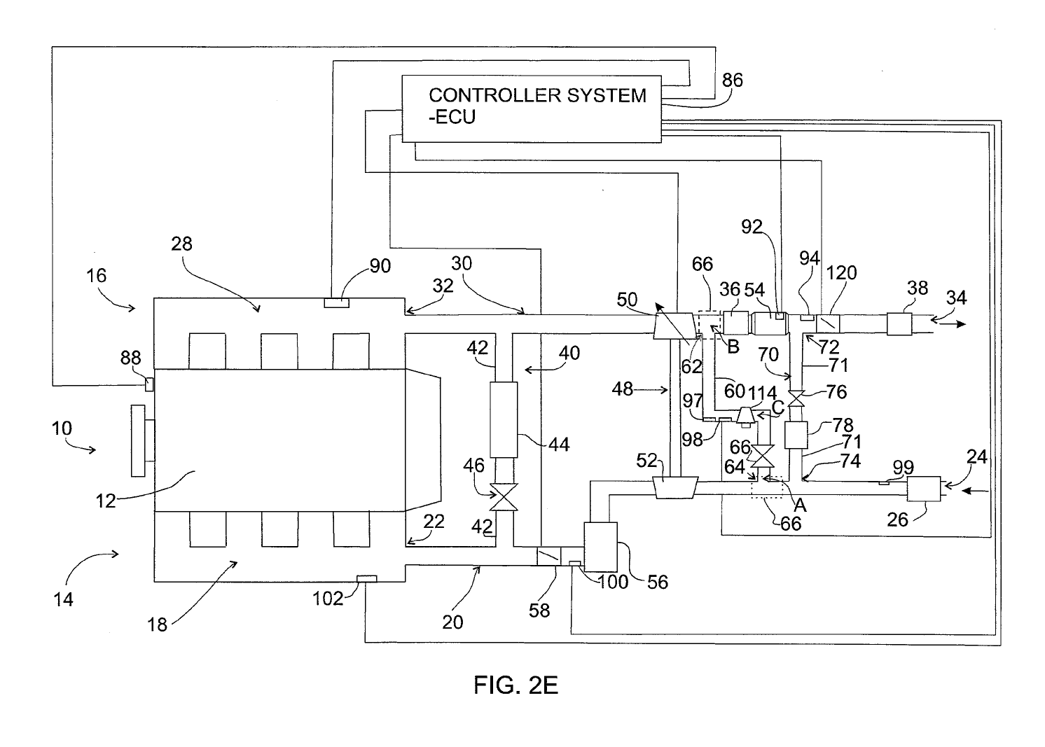

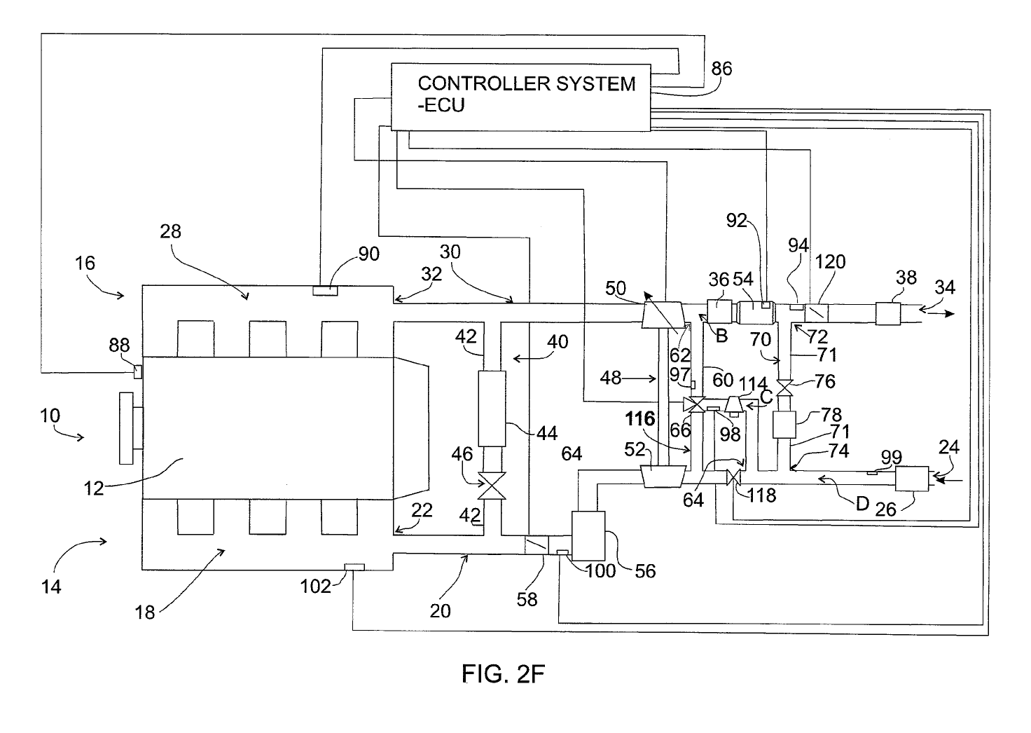

Referring now to FIG. 2A, one embodiment of the invention includes a product or system 10 which may include one or more of the following components. The system 10 may include a combustion engine 12, such as, but not limited to, a diesel combustion engine. The air intake side 14 may include an air intake manifold 18 connected to the combustion engine 12 to feed air into the cylinders of the combustion engine 12. A primary air intake conduit 20 may be provided and connected at one end 22 to the air intake manifold 18 (or made in part thereof), and may include an open end 24 for drawing air therethrough. An air filter 26 may be located at or near the open end 24 of the primary air intake conduit 20.

A combustion gas exhaust side 16 may be provided and constructed and arranged to discharge combustion exhausts from the combustion engine 12. The combustion gas exhaust side 16 may include an exhaust manifold 28 connected to the combustion engine 12 to exhaust combustion gases therefrom. The combustion gas exhaust side 16 may further include a primary exhaust gas conduit 30 having a first end 32 connected to the exhaust manifold 28 (or made in part thereof), and may have an open end 34 for discharging exhaust gases to the atmosphere.

The system 10 may further include a first exhaust gas recirculation assembly 40 extending from the combustion gas exhaust side 16 to the air intake side 14. A first exhaust gas recirculation (EGR) valve 46 may be provided in fluid communication with the primary exhaust gas conduit 30 or may be provided in a first exhaust gas recirculation line 42 and constructed and arranged to control the flow of exhaust gas through the first exhaust gas line 42, into the air intake side 14 and into the combustion engine 12. A cooler 44 may be provided in fluid communication with the first EGR line 42 for cooling exhaust gases flowing through the same.

In one embodiment the system may include a turbocharger 48 having a turbine 50 in fluid communication with the primary exhaust gas conduit 30 and having a compressor 52 in fluid communication with the primary air intake conduit 20 to compress gases flowing therethrough. In one embodiment of the invention, the turbine 50 may have a variable turbine geometry with turbine vanes movable from at least a first position to a second position to vary the geometry of the turbine and thus vary the speed of rotation of the turbine for a given flow rate therethrough. Variable turbine geometry devices are well known to those skilled in the art. An example of a variable turbine geometry device useful in various embodiments of the invention is described in Scholz et al, U.S. Pat. No. 7,114,919, issued Oct. 3, 2006. However, in certain embodiments of the invention a variable turbine turbocharger is not necessary.

Optionally, a second EGR assembly 70 may be provided for a low-pressure exhaust gas recirculation. The second EGR assembly 70 may be identically constructed as the first EGR assembly 40, if desired. In one embodiment, the second EGR assembly 70 includes a second EGR line 71 having a first end 72 connected to the primary exhaust gas conduit 30 and a second end 74 connected to the primary air intake conduit 20. A second EGR valve 76 may be provided in fluid communication with the primary exhaust gas conduit 30 or provided in the second EGR line 71. A second cooler 78 may be provided in fluid communication with the second EGR line 71 to cool exhaust gas flowing therethrough. The primary exhaust gas conduit 30 may include a throttle valve 120 to control the amount of exhaust gas being exhausted from the open end 34.

Additional components may be included in the primary exhaust gas conduit 30 including a particulate filter 54 located downstream of the turbine 50. A catalytic converter 36 may be located upstream of the particulate filter 54, and a muffler 38 may be located downstream of the catalytic converter 36.

According to one embodiment of the invention, air may be charged into the primary exhaust gas conduit 30 from the primary air intake conduit 20 through an air charge line 60 having a first end 62 connected to the primary exhaust gas conduit 30 and a second end 64 connected to the primary air intake conduit 20. An air valve 66 may be provided to control the flow of air through the air charge line 60. In one embodiment, the air valve 66 may be provided in the air charge line 60. In another embodiment, the air valve 66 may be a three-way valve located at the junction of the primary air intake conduit 20 and the air charge line 60 to control the flow of air through both the primary air intake conduit 20 and the air charge line 60 or the junction of the primary exhaust gas conduit 30 and the air charge line 60.

An air charge cooler 56 may be provided in fluid communication with the primary air intake conduit 20 and located downstream of the compressor 52. Optionally, an air throttle valve 58 may be located in the primary air intake conduit 20, preferably downstream of the air charge cooler 56.

A controller system 86, such as an electronic control module may be provided and may receive input from a variety of sensors, or other controllers or the like, including an engine sensor 88 which may provide signals regarding the engine speed or load. Not all sensor or input devices described herein show a line connecting them to the controller system 86 but it should be understood that such devices communicate information to the controller system 86 by hard wiring or any other means of data transfer. A first pressure sensor 90 may be provided in the exhaust manifold 28 and provide signals to the controller system 86. A second pressure sensor 92 may be located in or before the particulate filter 54 or downstream thereof to measure the pressure of the exhaust to determine indirectly the amount of soot accumulated in the particulate trap and the need to regenerate the same.

A first air pressure sensor 98 may be provided in the air charge line 60 and a second air pressure sensor 100 may be provided in the primary air intake conduit 20, preferably downstream from the air charge cooler 56. A temperature sensor 97 may also be provided in the air charge line 60. An air intake pressure sensor 102 and/or a mass flow sensor 99 may be provided in the air intake side 14 to measure the mass of air flowing therein.

The controller system 86 may receive input from a variety of sensors and such input may be used to control the position of the air throttle valve 58, the vane position of the turbine 50 (when variable) of the turbocharger 48, and/or the position of the air valve 66 to control the amount of air being injected into the primary exhaust gas conduit 30.

With respect to FIG. 2A, it is also possible for the second end 64 of the air charge line 60 to be connected to the primary air intake conduit 20 at a location downstream of the compressor 52.

Referring now to FIG. 2B, one embodiment of the invention includes a system similar to that described with respect to FIG. 2A but with the addition of a fuel burner 104 in fluid communication with the air charge line 60. The fuel burner 104 may be constructed and arranged and operated to create exhaust gas with a temperature sufficient to quickly regenerate the particulate filter 54. A sensor 106 may be associated with the fuel burner 104 to provide a signal indicative of property or operation condition thereof. The fuel burner 104 may burn the same fuel used by the combustion engine 12. The sensor 106 may be operatively connected to the controller system 86 and the controller system may control the flow of fuel and the ignition of the fuel burner 104.

Referring now to FIG. 2C, one embodiment of the invention is constructed similar to the embodiments shown in FIGS. 2A and 2B but with the addition of an air pump 108 in fluid communication with the air charge line 60. In one embodiment of the invention the air pump 108 is constructed and arranged to provide an air flow rate of about 2-25 cfm. The air charge line may be positioned downstream of the air valve 66. When the air pump is positioned in the air charge line 60 at a location between the first end 62 and the second end 64 the air pump can be of a simple design because it does not have to increase the pressure from the pressure at point A to the pressure at point B. The air pump 108 only needs to increase the pressure from point C to B. In the embodiment shown in FIG. 2C, the air pump 108 is precharged by the compressor 52. The pressure differential between the air in the line at point C and point B is typically smaller than the pressure differential between the air in the line at points A to B.

Referring now to FIG. 2D, one embodiment of the invention includes a system 10 constructed similar to that described with respect to FIG. 2A but with a heater 110 provided in fluid communication with the air charge line 60 to heat the air entering the primary exhaust gas conduit 30. The heater 110 may be any of a variety of types including electric heater or a passive heater, for example, by location of the air charge line 60 is adjacent to the hot turbocharger housing. A temperature sensor 112 may be associated with the heater 110 or provided in the air charge line 60 and connected to the controller system 86 to provide input indicative of the temperature of the air in the air charge line 60. The controller system 86 is constructed and arranged to control the operation of the heater 110 in response to a variety of inputs.

Referring now to FIG. 2E, another embodiment of the invention is similarly constructed to the invention shown in FIG. 2A, but wherein the second end 64 of the air charge line 60 may be connected to the primary air intake conduit 20 at a position upstream of the compressor 52. In this embodiment, a boost assist device 114 is provided in fluid communication with the air charge line 60. In one embodiment the boost assist device 114 is constructed and arranged to flow air at a rate greater than 30 cfm, and more preferably greater than 50 cfm. The boost assist device may be constructed and arranged to pressurize the air to at least 1.2 bar. In this embodiment an air valve 66 may be provided in the air charge line 60. The boost assist device 114 may be a mechanically, electrically or hydraulically or other driven device using a centrifuge or positive displacement compressor.

Referring now to FIG. 2F, another embodiment of the invention is similarly constructed to the invention shown in FIG. 2A, but wherein the second end 64 of the air charge line 60 may be connected to the primary air intake conduit 20 at a position upstream of the compressor 52. In this embodiment, a boost assist device 114 is provided in fluid communication with the air charge line 60. Again, the boost assist device 114 is constructed and arranged to flow air at a rate greater than 30 cfm, and more preferably greater than 50 cfm. The boost assist device may be constructed and arranged to pressurize the air to at least 1.2 bar. In another embodiment, a loop conduit 116 may be connected to the air charge line 60 at a location downstream of the boost assist device 114 and may be connected at the other end to the primary air intake conduit 20 at a position downstream from the connection of the second end 64 of the air charge line 60 to the primary air intake conduit 20. A bypass air valve 118 may be positioned in the primary air intake conduit 20 at a location downstream of the location of the connection of the second end 64 of the air charge line 60 to the air intake conduit 20 and upstream of the location of the connection of the loop conduit 116 to the primary air intake conduit 20. In this embodiment the air valve 66 is a three-way valve. When additional air is required in the primary exhaust gas conduit 30, the boost assist device 114 is turned on to flow air from point D in the primary air intake conduit 20 to point B in the primary exhaust gas conduit 30. When the boost assist device 114 is used to feed the compressor 52 with additional air, the air valve 66 may at least partially or completely close the path from the boost assist device 114 to the primary exhaust gas conduit 30 and at least partially opens the path from the boost assist device 114 to the primary air intake conduit 20 through the loop conduit 116. At the same time, the bypass air valve 118 is closed to avoid reverse flow. The boost assist device 114 may be a mechanically, electrically or hydraulically or other driven device using a centrifuge or positive displacement compressor.

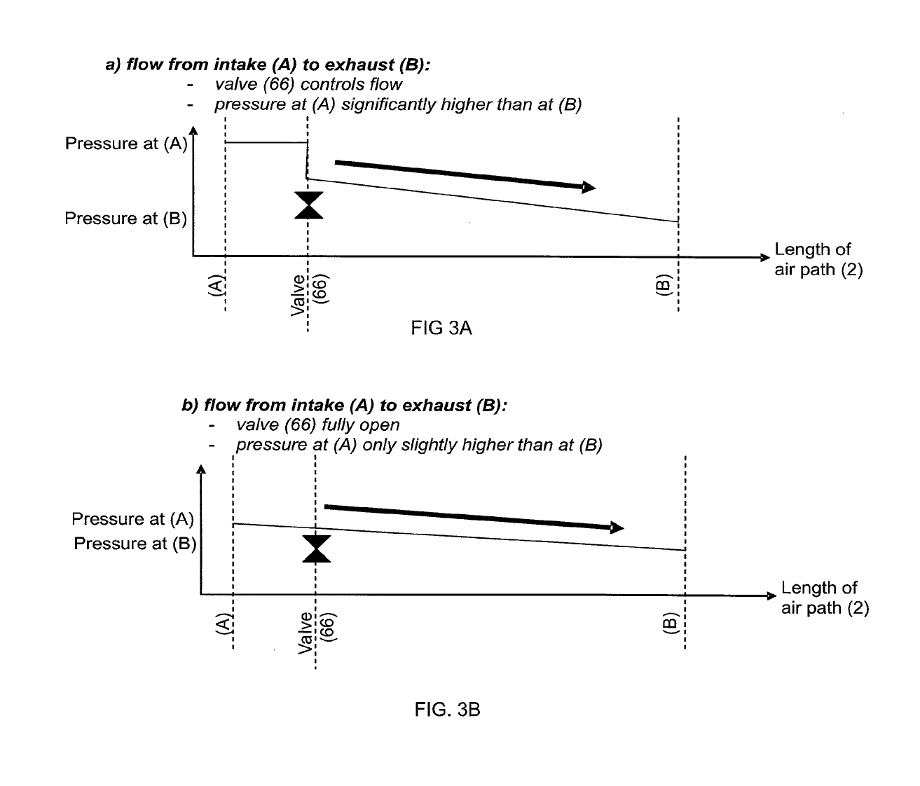

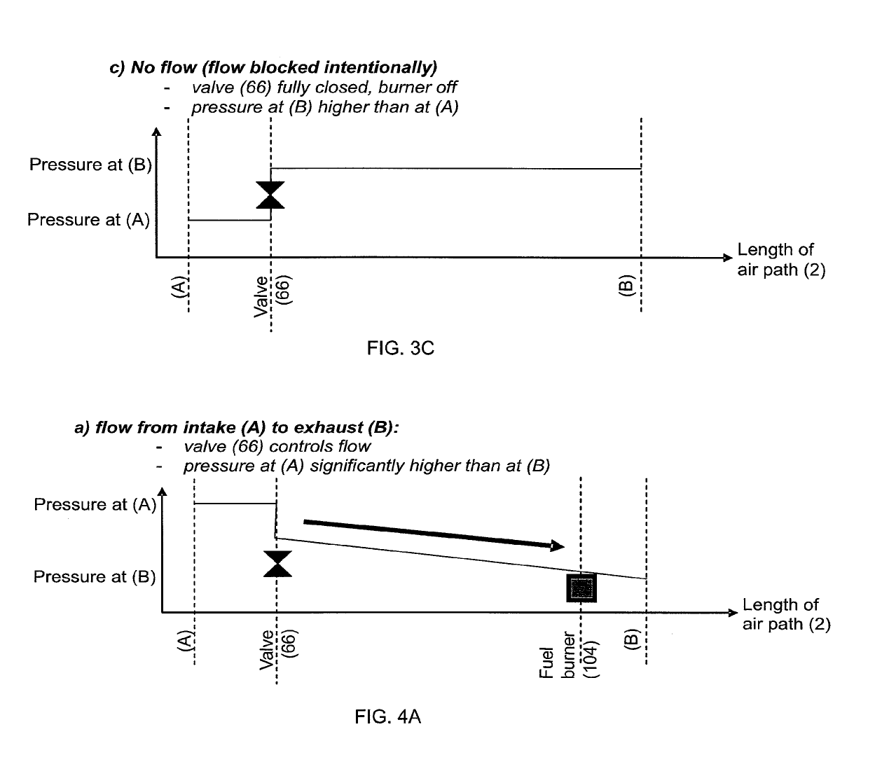

FIGS. 3A-3C are graphs illustrating various operating conditions using an air valve 66 in the air charge line 60 with no other device in the air charge line path in a configuration similar to that shown in FIG. 2A.

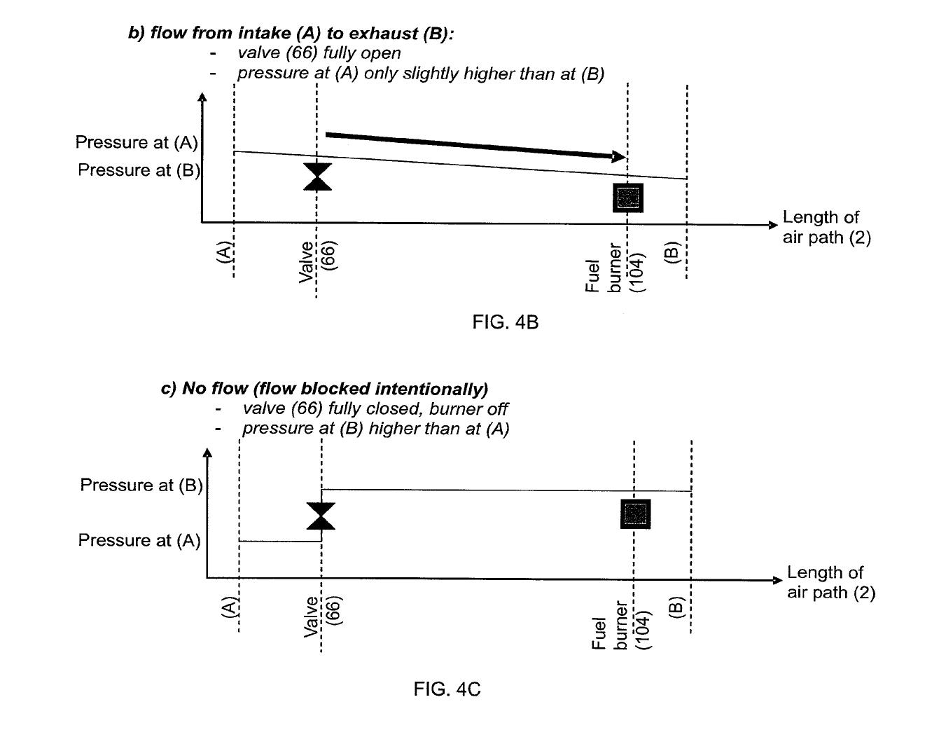

FIGS. 4A-4C illustrate various operating conditions for an embodiment including an air valve 66 and a fuel burner 104 in the air charge line 60. As shown in FIG. 4A, the air valve 66 may be used to control the airflow through the air charge line 60 wherein the pressure at point A is significantly higher than the pressure at point B. As shown in FIG. 4B, when the air valve 66 is fully open, the pressure at point A is only slightly higher than at point B. As shown in FIG. 4C, when the air valve 66 is completely closed and the fuel burner 104 is off, the pressure at point B is higher than the pressure at point A.

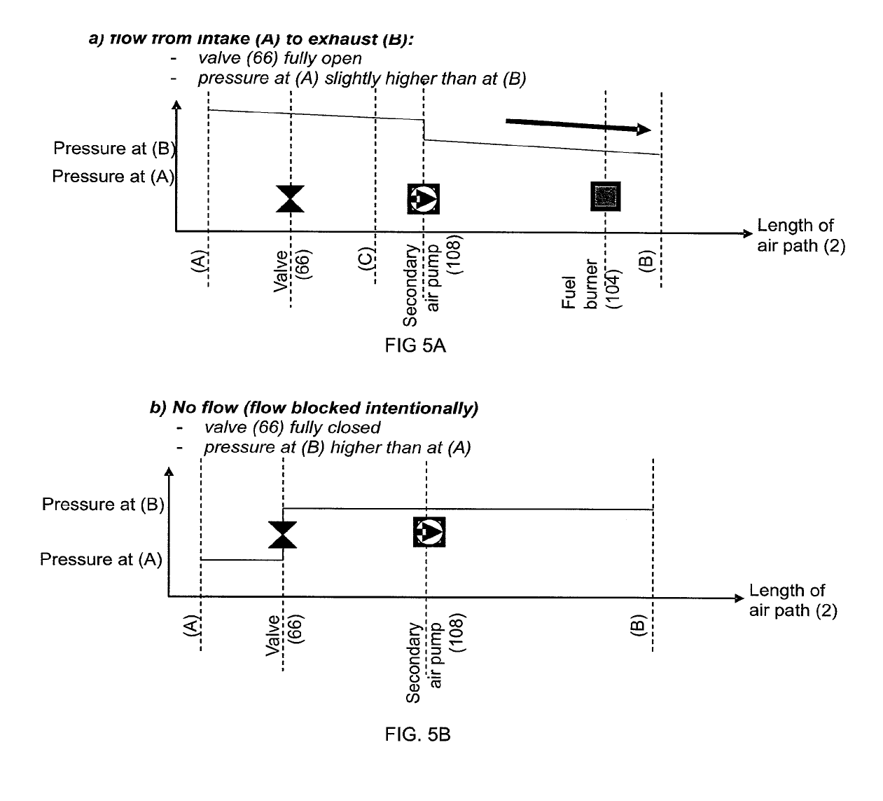

FIGS. 5A-5B are graphs of various operating conditions for a system including a fuel burner 104 and an air pump 108 such as that illustrated in FIG. 2C. As shown in FIG. 5A, when the air valve 66 is fully open, the pressure at point A is slightly higher than the pressure at point B. Referring to FIG. 5B, when the air valve 66 is fully closed, the pressure at point B is higher than the pressure at point A.

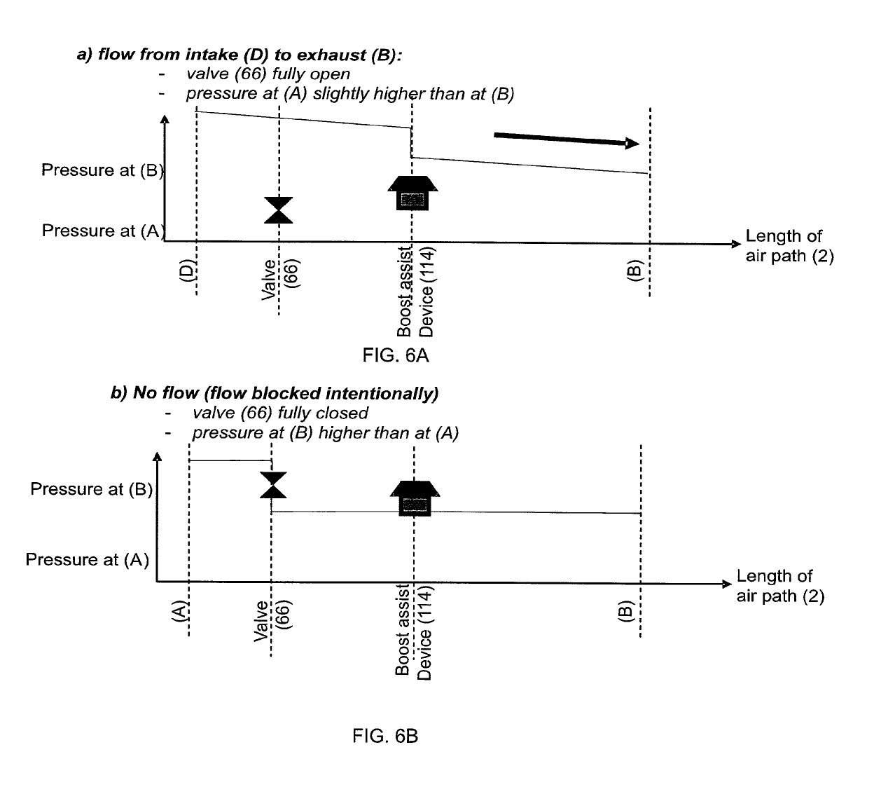

FIGS. 6A-6B illustrate various operating conditions for a system including a boost assist device 114 in the air charge line 60 such as that illustrated in FIG. 2E. Referring now to FIG. 6A, when the air valve 66 is fully open, the pressure at point A is slightly higher than the pressure at point B. Referring now to FIG. 6B, when the air valve 66 is fully closed to block the flow of air from the boost assist device 114 to the primary exhaust gas conduit 30, the pressure at point B is higher than the pressure at point A.

In the various embodiments described herein, it should be noted that if the pressure at point A is lower than the pressure at point B, flow will be reversed. This is an undesirable situation. For this reason the flow through the air charge line 60 should be monitored and controlled. This can be accomplished by measuring the pressure drop at a defined orifice in the air charge line 60, measuring the pressure drop in the air valve 66, using an alternative flow measuring device, or using the fuel burner 104 (integrated functions) for indirect flow measurements. The amount of flow passing through the air charge line 60 may be controlled: if the pressure at point A is lower than at point B, the pressure at point A should be increased. This can be done by adapting the turbine 50 (when variable) and adjusting the air throttle valve 58 accordingly to keep air intake flow constant. If the pressure at point A is too high and therefore the flow through the air charge line 60 exceeds a predetermined target, the air valve 66 can also be adjusted accordingly.

It should be appreciated that different variations of the components described herein may be utilized such as: a fixed geometry turbocharger turbine, a variable turbocharger compressor that allows for adjusting the pressure at point A without using a variable turbocharger turbine; using a two-stage turbocharging assembly with the air valve 66 downstream of the high pressure stage compressor, different air valve designs for valves 66 and 118, a valve combining the functions of air valve 66 with air throttle valve 58, and the use of any kind of supercharger or other types of air charger on combustion engines. Furthermore, the invention is not limited to diesel engines.

One embodiment of the invention includes using a charger, such as a turbocharger, as an auxiliary air delivery device. Another embodiment of the invention includes a method of using a turbocharger as an air pump to blow air into the combustion gas exhaust side 16. Another embodiment of the invention includes a method of using a turbocharger 48 to pre-charge an air pump 108. Another embodiment of the invention includes a method to preheat air being introduced into the combustion gas exhaust side 16. Another embodiment of the invention includes a method of using excess air from a compressor to cool after treatment devices. Another embodiment of the invention includes a method of using excess air coming from a boost assist device to provide air to the combustion gas exhaust side 16.

Another embodiment of the invention includes a control strategy to control the flow of air through the air charge line 60 including obtaining information indicative of the flow of air through the chargeair line. Such information might be obtained from the pressure drop through a venturi, by a mass flow meter, a signal from the fuel burner 104, or a signal from another location in the exhaust system when a fuel burner is not used. The obtained information is used to adjust at least one of the air throttle valve 58, turbine 50 (when variable), air valve 66, and boost assist device 114 to control the flow of air through the air charge line 60. The air throttle valve 58 may be positioned to build up pressure to push air into the primary exhaust gas conduit 30 when the air throttle valve 58 is substantially closed. The vanes of the turbine 50 may be adjusted (when variable) to vary the flow through the compressor (somewhat independent of the air throttle valve 58 position) so that when the air throttle valve 58 is in a fixed position and somewhat closed, charging the turbine power by adjusting the vane position increases compressor speed and can therefore increase the pressure after the compressor 52 to push air into the primary exhaust gas side 16.

The above description of embodiments of the invention is merely exemplary in nature and, thus, variations thereof are not to be regarded as a departure from the spirit and scope of the invention.

What is claimed is:

1. A method comprising:
providing a combustion engine breathing system comprising an air intake side and an exhaust side, the air intake side being constructed and arranged to be connected to a combustion engine to deliver air into the cylinders thereof and the exhaust side being constructed and arranged to be connected to the combustion engine for exhausting combustion gases to the atmosphere, a turbocharger comprising a turbine in fluid communication with the exhaust side, and a compressor in fluid communication with the air intake side, and an auxiliary conduit connected to the air intake side at a location downstream of the compressor;
using the compressor to selectively force air through the auxiliary conduit into an exhaust conduit.

2. A method as set forth in claim 1 wherein the auxiliary conduit is an air charge line having a first end connected to the air intake side, and having a second end connected to the exhaust side to selectively inject air into the exhaust side.

3. A method as set forth in claim 2 wherein the exhaust side further includes a particulate filter, and wherein the second end of the air charge line is connected to the exhaust side at a location upstream of the particulate filter.

4. A method as set forth in claim 2 further comprising a catalytic converter in fluid communication with the exhaust side, and wherein the second end of the air charge line is connected to the exhaust side at a location upstream of the catalytic converter.

5. A method as set forth in claim 2 further comprising a particulate filter in fluid communication with the exhaust side and a catalytic converter in fluid communication with the exhaust side and wherein the second end of the air charge line is connected to the exhaust side at a location interposed between the particulate filter and the catalytic converter.

6. A method as set forth in claim 2 further comprising a boost assist device in fluid communication with the air charge line, the boos assist device being constructed and arranged to pressurize the air to at least 1.2 bar.

7. A method as set forth in claim 6 wherein the boost assist device is constructed and arranged to blow air through the air charge line at a rate of at least 30 cfm.

8. A method as set forth in claim 6 further comprising a fuel burner in fluid communication with the air charge line at a location downstream of the boost assist device.

9. A method as set forth in claim 2 further comprising an air valve in fluid communication with the air charge line and constructed and arranged to control the amount of air flowing through the air charge line.

10. A method as set forth in claim 9 wherein the air valve is a three-way valve located at the junction of the air charge line and the air intake side.

11. A method as set forth in claim 2 further comprising a fuel burner in fluid communication with the air charge line and constructed and arranged to heat air passing through the air charge line.

12. A method as set forth in claim 11 further comprising an air pump in fluid communication with the air charge line and positioned upstream of the fuel burner and constructed and arranged to pump air through the air charge line.

13. A method as set forth in claim 1 further comprising an air pump in fluid communication with the auxiliary conduit and wherein the compressor and the auxiliary conduit is constructed and arranged so that the compressor pre-charges the air pump.

14. A method as set forth in claim 2 further comprising a heater in fluid communication with the air charge line to heat air passing there through.

15. A method as set forth in claim 14 wherein the heater comprises an electrical heater.

16. A method as set forth in claim 14 wherein the heater comprises a passive heater.

17. A method as set forth in claim 2 further comprising a boost assist device in fluid communication with the air charge line and constructed and arranged to blow air through the air charge line, and a loop conduit having a first end connected to the air intake side and a second end connected to the air charge line at a location downstream of the boost assist device and a three-way valve positioned at the juncture of the loop conduit and the air charge line, and selectively controlling the three-way valve to allow air to flow through the air charge line to the exhaust side and through the loop conduit back to the air intake side.

18. A method as set forth in claim 17 further comprising a bypass air valve positioned in the air intake side at a location interposed between the connection of the air charge line to the air intake side and the connection of the loop conduit to the air intake side, and selectively controlling the three-way valve to allow air to flow from the air intake side to the exhaust side, and selectively controlling the three-way valve to allow air to flow through the loop conduit back to the exhaust side, and closing the bypass valve when the air is flowing through the loop conduit to at least partially prevent reverse flow in the air intake side towards an open end thereof.

19. A method as set forth in claim 18 further comprising driving the boost assist device using at least one of mechanical, electrical or hydraulic power.

20. A method as set forth in claim 9 further comprising obtaining information indicative of the flow of air through the air charge line and adjusting the air valve in response to the information.

21. A method as set forth in claim 2 wherein the turbine is a variable vane turbine and further comprising obtaining information indicative of the air flow through the air charge line and adjusting the vane position of the variable vane turbine in response to the information.

22. A method as set forth in claim 2 further comprising an air intake throttle valve positioned in the air intake side at a location downstream of the junction of the air charge line and the air intake side, and obtaining information indicative of the air flow through the air charge line and adjusting the air intake throttle valve in response to the information.

23. A method as set forth in claim 9 and further comprising a controller system constructed and arranged to receive at least one input indicative of at least one operating condition in the engine breathing system, and wherein the controller system is constructed and arranged to control the position of the air valve and controlling the position of the air valve in response to the input.

24. A method as set forth in claim 2 wherein the turbine has a variable turbine geometry comprising adjustable vanes and further comprising a controller system constructed and arranged to receive at least one input indicative of at least one operating condition in the engine breathing system, and the controller system being constructed and arranged to adjust the position of the vanes of the turbine and adjusting the position of the vanes in the turbine in response to the input.

25. A method as set forth in claim 2 and further comprising an air intake throttle valve positioned downstream of the junction of the air charge line and the air intake side, and further comprising a controller system constructed and arranged to receive at least one input indicative of at least one operating condition in the breathing system, and controlling the position of the air intake throttle valve in response to the input.

26. A method as set forth in claim 11 further comprising a controller system constructed and arranged to receive at least one input indicative of at least one operating condition within the breathing system, and the controller system being constructed and arranged to control the heat generated by the fuel burner, and controlling the heat generated by the fuel burner in response to the input.

27. A method as set forth in claim 13 further comprising a controller system constructed and arranged to receive at least one input indicative of at least one operating condition in the breathing system, and the controller system being constructed and arranged to control the air pump and controlling the air pump in response to the input.

28. A method as set forth in claim 14 further comprising a controller system constructed and arranged to receive at least one input indicative of at least one operating condition in the breathing system, and the controller system being constructed and arranged to control the heat generated by the heater, and controlling the heat generated by the heater in response to the input.

29. A method as set forth in claim 2 wherein a first end of the air charge line is connected to the air intake side at a position downstream of the compressor.

30. A method as set forth in claim 2 wherein a first end of the air charge line is connected to the air intake side at a location upstream of the compressor.

31. A method comprising:
providing a combustion engine breathing system including an air intake side constructed and arranged to deliver air to the cylinders of a combustion engine, and a combustion gas exhaust side constructed and arranged to expel combustion gases from the cylinders to the atmosphere, an air charge line extending from the air intake side to the exhaust side, a first component, a controller system constructed and arranged to receive at least one input indicative of an operating condition in the breathing system, obtaining the input and adjusting the first component and altering the flow rate of air through the air charge line or the temperature of the air in the air charge line in response to the input.

32. A method as set forth in claim 31 wherein the input is at least one of information indicative of the engine speed, engine load, temperature of the gas in the exhaust side, the back pressure in the exhaust side, the amount of soot in a particulate filter in the exhaust side, the amount of an exhaust gas constituent, the flow rate in the air charge line, the temperature of the air in the air charge line, the flow rate of air in the air charge line, the pressure of air in the air intake side or the mass flow rate of air in the air intake side before entering the engine.

33. A method as set forth in claim 31 wherein the first component comprises at least one of an air valve in fluid communication with the air charge line, a fuel burner in fluid communication with the air charge line to heat air flowing through the air charge line, a secondary air pump in fluid communication with the air charge line to pump air through the air charge line, a boost assist device in fluid communication with the air charge line, a heater in fluid communication with the air charge line to heat air flowing through the air charge line, a throttle valve in the air intake side or a throttle valve in the exhaust side or a variable turbocharger.

34. A method comprising:
providing a combustion engine breathing system including an air intake side constructed and arranged to deliver air into cylinders of a combustion engine, and an exhaust side constructed and arranged to expel exhaust gases from the cylinders to the atmosphere, and an air charge line extending from the air intake side to the exhaust side;
controlling a condition of the air in the air charge line.

35. A method as set forth in claim 34 wherein the condition of the air in the air charge line is the flow rate of air.

36. A method as set forth in claim 34 wherein the condition of the air in the air charge line is the temperature of the air.

37. A product comprising:
a combustion engine breathing system including an air intake side constructed and arranged to deliver air into cylinders of a combustion engine, and an exhaust side constructed and arranged to expel exhaust gases from the cylinders to the atmosphere, and an air charge line extending from the air intake side to the exhaust side.

38. A product as set forth in claim 37 further comprising a turbocharger comprising a turbine in fluid communication with the exhaust side, and a compressor in fluid communication with the air intake side.

39. A product as set forth in claim 38 wherein the air charge line is connected to the air intake side at a location downstream of the compressor.

40. A product as set forth in claim 38 wherein the air charge line is connected to the air intake side at a location upstream of the compressor.

41. A product as set forth in claim 39 further comprising an air valve in the air charge line.

42. A product as set forth in claim 39 further comprising a fuel burner in fluid communication with the air charge line to heat air flowing therethrough.

43. A product as set forth in claim 39 further comprising a heater in fluid communication with the air charge line to heat air flowing therethrough.

44. A product as set forth in claim 43 wherein the heater is one of an electric heater or a passive heater.

45. A product as set forth in claim 39 further comprising an air pump in fluid communication with the air charge line and wherein the compressor pre-charges the air pump.

46. A product as set forth in claim 37 further comprising a boost assist device in fluid communication with the air charge line, and wherein the boost assist device is constructed and arranged to pressurize the air to at least 1.2 bar.

47. A product as set forth in claim 40 further comprising a boost assist device in fluid communication with the air charge line and constructed and arranged to blow air through the air charge line, and a loop conduit having a first end connected to the air intake side and a second end connected to the air charge line at a location downstream of the boost assist device and a three-way valve positioned at the juncture of the loop conduit and the air charge line for selectively controlling the three-way valve to allow air to flow through the air charge line to the exhaust side and through the loop conduit back to the air intake side.

48. A product as set forth in claim 47 further comprising a bypass air valve positioned in the air intake side at a location interposed between the connection of the air charge line to the air intake side and the connection of the loop conduit to the air intake side.

49. A product as set forth in claim 48 further comprising a fuel burner or heater in fluid communication with the air charge line to heat the air flowing there through.

50. A product as set forth in claim 38 wherein the turbocharger includes a turbine having a variable turbine geometry.

51. A method as set forth in claim 3 further comprising a catalytic converter, a housing and wherein the particulate filter and the catalytic converter are received in the housing.

52. A method as set forth in claim 3 further comprising a catalytic coating on at least a portion of the particulate filter.

53. A method as set forth in claim 34 wherein the condition is the pressure in the air charge line.

54. A product as set forth in claim 38 wherein the turbocharger comprises a variable compressor constructed and arranged to variably increase the pressure of gas flowing therethrough under certain operating conditions.
